(19) United States
(12) Patent Application Publication
(10) Pub. No.: US 2007/0182708 A1
(43) Pub. Date: Aug. 9, 2007

(54) Tactile and force feedback device

(75) Inventors: Ivan Poupyrev, Tokyo (JP); Shigeaki Maruyama, Kanagawa (JP); Tyler Daniel, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: SONY CORPORATION, Tokyo (JP)

(21) Appl. No.: 10/567,027

(22) PCT Filed: Jul. 12, 2004
(86) PCT No.: PCT/JP04/09926

§ 371 Date: Jul. 25, 2006

(30) Foreign Application Priority Data
Aug. 6, 2003 (JP) P2003-287988

(51) Int. Cl. G09G 5/00

(52) U.S. Cl. 345/156

(57) ABSTRACT

Disclosed is a system including a tactile feedback device with which a user can sense the tactile force that is applied by the user on actuating a button or the like. The system includes a main body part (10), an operating unit (20) on which the user acts for inputting for interfacing with the main body part, and a display part (30) for demonstrating an image consistent with the current state of an interface program and an application program. The operating unit includes an interfacing element (22) for accepting an inputting operation from the user and a piezo actuator (21) for presenting a tactile feedback to the user performing the inputting operation on the operating unit. The piezo actuator is mounted on the interfacing element.

### TECHNICAL FIELD

This invention relates to an apparatus for presenting tactile feedback for a user. More particularly, the present invention relates to a tactile feedback apparatus for a human interface control device directly acted on by a user's finger, such as a switch, a button or a joystick.

The present invention contains subject matter related to Japanese Patent Application JP 2003-287988, filed in the Japanese Patent Office on Aug. 6, 2003, the entire contents of which being incorporated herein by reference.

### BACKGROUND ART

The force feedback is among critical elementary functions for a variety of control devices, such as buttons or joysticks. A rubber pad, provided on a mechanical switch or mechanism, is routinely used for presenting such tactile feedback. In such conventional control devices, the sort of the tactile feedback may not be changed, while it is not possible to change the tactile sense on actuation by the user of the interfacing element, using a computer application program, for presenting the sense of actuation of the user interface element more effectively to the user.

An example of adding a tactile feedback function to a force joystick has been disclosed in Campbell, C., S. Zhai, K. May and P. Maglio, What you feel must be what you see: Adding tactile feedback to the trackpoint, In Interact '99. 1999 p. 383-390.

An example of a mouse button having a tactile feedback function is disclosed in Akamatsu, M. and S. Sato, A multi-modal mouse with tactile and force feedback, International Journal of Human-Computer Studies, 1994, 40(3): p. 443-453.

In the examples, disclosed in the above Publications, there is used a solenoid element limited in the bandwidth of the frequency of the vibrations that can be presented. Moreover, the solenoid element is so large in size that it cannot be mounted on a small-sized device, such as joystick of a controller for a game or a button used on a camera. In addition, in the above devices, the tactile feedback is not correlated with the magnitude of the force that has been applied.

In a mobile phone or a game controller, a motor for generation of vibrations is used. As an example, there is a game controller having two motors generating vibrations for presenting the tactile feedback. Such motor, adapted for generating vibrations, includes a non-symmetrical shaft, and vibrations are initiated when the rpm of the motor has surpassed a preset value. However, the motor for generating the vibrations is extremely slow in reaction and hence is difficult to use for interactive usage in need of prompt response. Moreover, for a usage such as for a game, vibrations at higher frequencies do not prove to be effective feedback.

In Yoshie M., Yano H. and Iwata, H., Development of non-grounded force display using gyro moments, Proceedings of Human Interface Society Meeting 2001, pp. 25-30, and in Fukui Y., Nishihara S., Nakata K., Nakamura, J. and Yamashita J., Hand-held torque feedback display, Proceedings of SIGGRAPF01 Abstracts and Applications. 2001, ACM, pp 192), there is proposed a torque-based tactile feedback apparatus.

In the techniques disclosed in the above Publications, a rotating motor is used, and the torque generating on starting and terminating the motor rotation is used as feedback. The devices used in these techniques are large in size and weight and hence are difficult to use on a small-sized site on a game controller. In addition, only a highly limited tactile pattern may be generated by these devices. Moreover, the tactile bandwidth is narrow due to the force of inertia of the motor. For these reasons, the usage of these devices is mainly limited to force feedback devices.

The technique of directly stimulating the user's hand by plural piezo actuators, arranged in a matrix configuration, has been disclosed in Cholewiak, R. and C. Sherrick, A computer-controlled matrix system for presentation to skin of complex spatiotemporal pattern, Behavior Research Methods and instrumentation, 1981. 13(5): pp. 667-673. This piezo actuator is used by itself and is not intended to be used along with an interface controller mechanism, such as a switch or a button.

The technique of generating the tactile feedback using a voice coil has been disclosed in Fukumoto M. and Toshiaki, S., Active Click: Tactile Feedback for Touch Panels, Proceedings of CHI '2001, Extended Abstracts 2001, ACM, pp. 121-122. This tactile feedback is limited to local oscillations. Moreover, the voice coil is large-sized and usually can generate only the vibrations at a natural frequency proper to the voice coil. Hence, the tactile feedback has only a limited pattern.

In the JP Laid-open Patent Publication H-11-212725, there are disclosed an information display apparatus and an operation inputting apparatus employing plural piezoelectric elements for detecting a user's input on an information display and for presenting tactile feedback consistent with the user's input. In the technique disclosed in this Laid-open Patent Publication, high frequency signals are supplied for driving the piezoelectric elements and vibrations are generated for presenting the tactile feedback.

With the technique disclosed in this Laid-open Patent Publication, the amplitude of vibrations of the piezoelectric elements is small, while there lacks the disclosure of a mechanism for generating larger tactile feedback. An extremely large voltage is required for these piezoelectric elements per se to generate larger tactile feedback. Furthermore, only the method for application to an LCD is disclosed in the above Patent Publication 1. The system disclosed is such that, if an LCD display is thrust with a force larger than a preset threshold value, the tactile feedback having a preset magnitude is presented.

### DISCLOSURE OF THE INVENTION

### Problems to be Solved by the Invention

It is an object of the present invention to provide a novel tactile feedback apparatus whereby the problems of the above-described conventional techniques may be resolved.

It is another object of the present invention to provide a tactile feedback apparatus that may be applied to a human interface control device, such as a button or a controller, and a system including the tactile feedback apparatus as a human interface control apparatus.

It is a further object of the present invention to provide a tactile feedback apparatus that is able to present a larger force feedback that may readily be recognized by the user.

It is yet another object of the present invention to provide a tactile feedback apparatus in which the tactile feedback presented may be correlated with the force applied from the user.

### MEANS FOR SOLVING THE PROBLEMS

The present invention provides a tactile feedback apparatus comprising an interfacing element acted on by a user, and a piezo actuator arranged on the interfacing element for presenting tactile feedback to a user acting on the interfacing element. The piezo actuator has a circular-shaped multi-layered structure and has a shape changed to an upturned dome shape or to a downturned dome shape on application of voltages of opposite polarities to a plurality of layers in an upper portion of the multi-layered structure and to a plurality of layers in a lower portion of the multi-layered structure.

At least one of the amplitude and the frequency in a change between the upturned dome shape and the downturned dome shape is determined depending on a user's input mediated by the interfacing element.

The tactile feedback apparatus may further include a force sensor for detecting the force applied at the time of the inputting operation by a user. Preferably, the tactile feedback presented to the user is correlated with the force detected. Specifically, it is more preferred that at least one of the amplitude and the frequency in a change between the upturned dome shape and the downturned dome shape is determined depending on the force as detected by the force sensor or on the user's input applied via the interfacing element. Hence, with the tactile feedback apparatus according to the present invention, the user can feel the tactile response changing with the magnitude of the force applied by the user.

The interfacing element, used in the tactile feedback apparatus according to the present invention, may be exemplified by a joystick type operating device of a controller for playing a game, and a button or a switch provided to a large variety of consumer apparatus in need of such button or switch.

The present invention also provides a system comprising a main body part executing an application program and a user interface program and a control device mounted in separation from the main body part and adapted for controlling the state of the application program. In the system of the present invention, the control device includes an interfacing element acted on by a user and a piezo actuator arranged on the interfacing element for presenting tactile feedback to a user acting on the interfacing element. The piezo actuator has a circular-shaped multi-layered structure and has a shape changed to an upturned dome shape or to a downturned dome shape on application of voltages of opposite polarities to a plurality of layers in an upper portion of the multi-layered structure and to a plurality of layers in a lower portion of the multi-layered structure.

The tactile feedback apparatus according to the present invention has the following configuration.

That is, the tactile feedback apparatus includes

(a) a human interface controller directly acted on by a user' finger, such as a switch, button or a joystick;

(b) a circular-shaped single-layer or multi-layer piezo actuator mounted to the human interface controller;

(c) a hardware component and a software system for generating driving signals of an optional waveform for generating optional vibrations in the piezo actuator; and

(d) another software system for accepting inputs from the human interface controller and for controlling the hardware component and the software system, responsive to the current status of the user interface/application program for presenting proper tactile feedback to the user.

The above software systems may be implemented by a computer executing a proper application program.

### FAVORABLE EFFECT OF THE INVENTION

According to the present invention, there may be provided a tactile feedback apparatus, particularly applicable to a human interface control device, such as a button or a controller, and a system including this tactile feedback apparatus as a human interface control apparatus.

According to the present invention, there may be provided a tactile feedback apparatus that is able to present larger tactile feedback that may readily be recognized by the user.

According to the present invention, there may be provided a tactile feedback apparatus in which the force applied by the user may be correlated with the tactile feedback.

Other objects and specified advantages of the present invention will become more apparent from the following explanation of preferred embodiments thereof especially when read in conjunction with the drawings.

### BRIEF DESCRIPTION OF THE DRAWINGS

FIG. 1 is a schematic block diagram showing a system employing a tactile feedback apparatus according to the present invention.

FIG. 2 is a schematic block diagram showing another example of the system employing a tactile feedback apparatus according to the present invention.

FIG. 3A is a perspective view showing a piezo actuator according to the present invention, FIG. 3B is a perspective view showing the state in which the piezo actuator according to the present invention is bowed upwards and FIG. 3B is a perspective view showing the state in which the piezo actuator according to the present invention is bowed downwards.

FIG. 4 is a cross-sectional view showing an example of an operating unit used in the tactile feedback apparatus according to the present invention.

FIG. 5 is a perspective view showing another example of an operating unit used in the tactile feedback apparatus according to the present invention.

FIG. 6 is a perspective view showing an example of a control device for a game according to the present invention.

### BEST MODE FOR CARRYING OUT THE INVENTION

Referring to the drawings, preferred embodiments of the present invention will be explained in detail.

(1) System Structure

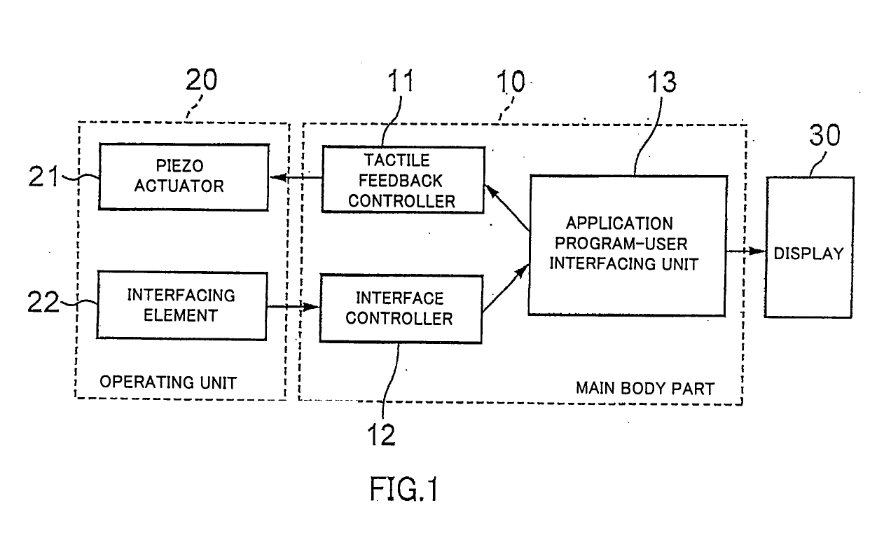

Referring to FIG. 1, an example of system structure employing the present invention will be explained. As shown in FIG. 1, the present system includes a main body part 10, an operating unit 20 on which a user acts by way of an inputting operation for interfacing with the main body part 10, and a display part 30 for demonstrating an image consistent with the current state of the interface and the application program.

The operating unit 20 includes an interfacing element 22, accepting the user's inputting operation, and a piezo actuator 21 for generating tactile feedback for a user performing an inputting operation on the operating unit 20. Details and a concrete structure of the piezo actuator 21 will be explained subsequently. The interfacing element 22 is any optional user interface controller, such as a button or a joystick.

It is more preferred that the piezo actuator 21 is mounted on the interfacing element 22. However, the structures of the piezo actuator 21 and the interfacing element 22 are not limited to any particular structures and may be of any suitable type on the condition that tactile feedback such as mechanical vibrations generated in the piezo actuator 21 may thereby be transmitted to the user's finger or hand performing an inputting operation on the operating unit 20.

The main body part 10 includes an interface controller 12, receiving a signal output from the interfacing element 22 responsive to the user's inputting operation, a tactile feedback controller 11 for driving controlling the piezo actuator 21, and an application program-user interfacing unit 13 for executing an application program and a user interface program and for outputting a control signal controlling the movement of the piezo actuator 21 to the tactile feedback controller 11 responsive to the user's inputting operation. The application program-user interfacing unit 13

In the system shown in FIG. 1, in case a user performs an inputting operation on the interface controller 12, via interfacing element 22, such as by pressing a button or causing movement of the joystick, the user is provided with a tactile feedback from the piezo actuator 21. This piezo actuator 21 is controlled by the tactile feedback controller 11 generating a control signal. This control signal is a voltage signal, which is a function of time, and which may be of an amplitude, a waveform and a period as determined by an interface implementer determining which tactile feedback is to be presented to different inputting operations. The control signal may, for example, be a rectangular wave or a sine wave.

The control signal may be generated from the application program and from the user interface program, responsive to an input signal from the interface controller 12. The control signal is generated is generated in keeping with the current state of the application program and the user interface program exploited in the present system.

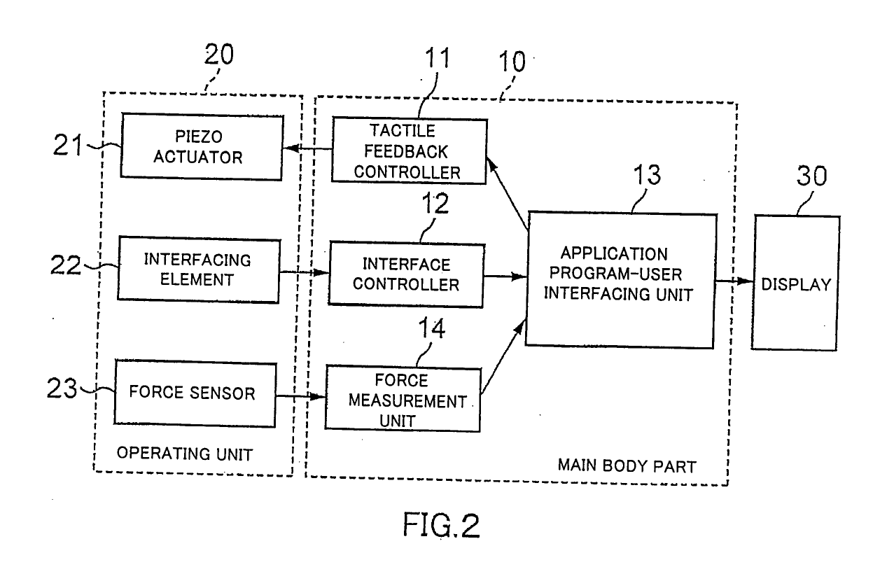

FIG. 2 shows a modification of the system embodying the present invention. The system shown in FIG. 2 includes, in addition to the elements included in the system of FIG. 1, a force sensor 23 and a force measurement unit 14, for detecting the force applied to the interfacing element 22 by the user. The force sensor 23 may be comprised of a pressure sensor or any other suitable sensor capable of directly or indirectly detecting the user's force.

In the system of FIG. 2, the force at the time of the inputting operation is measured by the force measurement unit 14 and sent to the application program-user interfacing unit 13 along with the signal from the interface controller 12. The tactile feedback, presented by the system of the present invention, is correlated with the force applied by the user to the operating unit 20, such as a button or a joystick for playing a game.

(2) Components and Structure of the Tactile Interface

The piezo actuator 21 is a source of motive power for tactile feedback and includes a single layer or plural layers of piezoelectric elements having a shape corresponding or conforming to the shape of the interfacing element 22.

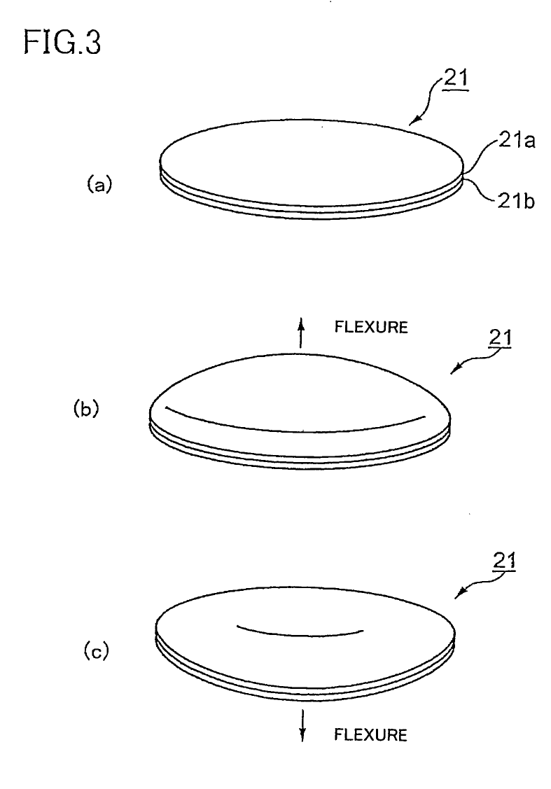

FIG. 3A shows an example of the piezo actuator 21. In this particular example, the main component of the piezo actuator 21 is a bowed circular multi-layered piezo actuator having a multi-layered structure of a thin-filmed piezo-ceramic material, with electrodes sandwiched between neighboring actuator layers.

The piezo actuator 21, shown in FIG. 3A, is e.g. of the bimorph type, made up by an upper actuator unit 21a and a lower actuator unit 21b, each having an electrode sandwiched in-between.

The piezoelectric material is expanded or contracted, depending on the direction of the voltage applied. When the voltages of opposite polarities are applied to the upper actuator unit 21a and to the lower actuator unit 21b, one of the units is contracted, while the other is expanded, as a result of which the piezo actuator 21 has its upper section or lower section expanded on the whole to assume a dome-like shape. In FIG. 3A, the piezo actuator 21 is shown in a neutral state in which no voltage is applied to the piezo actuator 21. In FIGS. 3B and 3C, the piezo actuator 21 is shown in a bowed state in which it is bowed responsive to application of voltages of opposite polarities.

The piezo actuator 21, shown in FIGS. 3A to 3C, is of a circular shape. However, the piezo actuator 21 of the present invention is not limited to this particular shape. The piezo actuator 21 may be of an elliptical or any other suitable shape, if the piezo actuator may be mounted on the interfacing element 22 as later explained and may be changed in shape to present an upwardly or downwardly bowed dome shape responsive to a driving signal applied.

The electrodes for supplying driving signals to the respective layers of the piezo actuator 21 are mounted on a peripheral or central area of the circular piezo actuator 21, by exploiting e.g., through-holes interconnecting the plural layers. When the piezo actuator 21 is bowed, the center area of the piezo actuator 21 is deformed to a lesser extent than the other area, in order to prevent the piezo actuator 21 from becoming damaged at this time.

The piezo actuator 21 in its entirety may be covered by e.g. a polymer material, in order that the user will not become aware of the electrode mounted to the piezo actuator 21. It is also possible to use a casing in which to accommodate the piezo actuator 21. Any suitable type of the casing may be used, provided that such casing allows the center area of the piezo actuator 21 to be deformed.

Since the force of bowing of the piezo actuator 21 is directly proportionate to the voltage, and the piezoelectric element of the multi-layered structure is exploited, the piezo actuator 21 of the present embodiment is able to present tactile feedback by vibrations large enough to be recognized by the user.

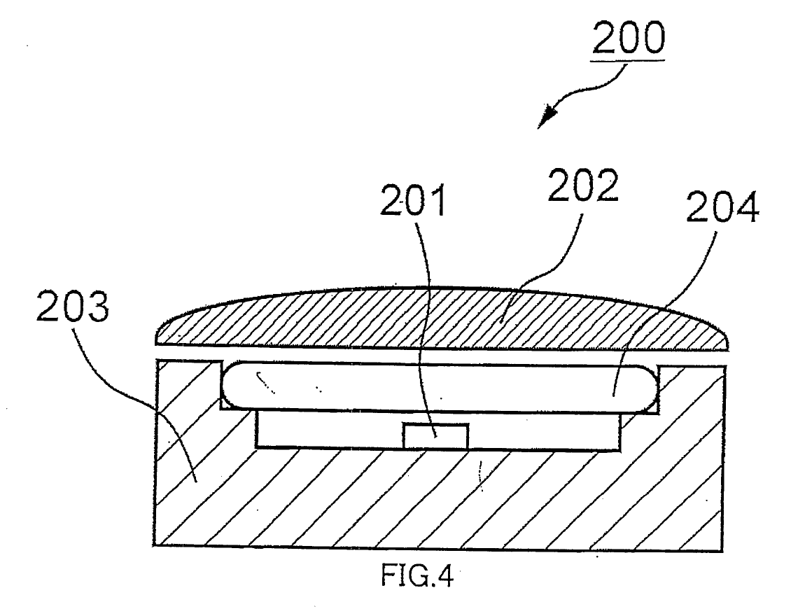

FIG. 4 shows an example of a particular structure of the operating unit 20 constituting the system shown in FIG. 1. In FIG. 4, a control apparatus 200 for playing a game, provided with a piezo actuator 204, is shown. The piezo actuator 204 is constructed similarly to the piezo actuator 21 described above.

A casing 203, included in the control apparatus 200 for playing a game, has an inner structure and a spacing for holding the piezo actuator 204 therein and for allowing the piezo actuator 204 held therein to be bowed in an up-and-down direction when the piezo actuator 204 presents an upturned or downturned dome shape. A stopper 201 plays the part of preventing excessive bowing of the piezo actuator 204 when the user is running the program of the control apparatus 200 for playing a game. A cover 202 is provided for convenience in user's operations and for preventing the user from directly contacting the piezo actuator 204. For the cover 202, a cap formed e.g. of rubber may be used. The component forming the cover 202 is preferably such a component that does not appreciably attenuate the vibrations generated by the piezo actuator 204.

The piezo actuator 204 is mounted to the casing with its peripheral part to permit its center portion to be displaced in the up-and-down direction responsive to driving signals.

The piezo actuator 204 is bonded or mounted with an adhesive. Or, it may be simply retained by any proper mechanical structure. For example, the piezo actuator 204 may be immovably fitted in a groove formed in a wall section of the casing 203. The principal condition, imposed in this structure, is that it is possible to prevent the piezo actuator 204 from becoming excessively bowed on user actuation, as the bowing in the up-and-down direction of the piezo actuator 204 is allowed. It may be said that the stopper 201 is provided in this particular embodiment for preventing this excessive bowing.

Turning to the structure of the control apparatus 200, such a structure prohibiting such excessive bowing or bowing in a direction different than the direction perpendicular to the actuator surface is desirable. It is also more desirable that the piezo actuator 204 is mounted to the control apparatus 200 in such a manner that, when the user acts on the control apparatus 200, the force will be acting only in a direction perpendicular or substantially perpendicular to the surface of the piezo actuator 204.

The interfacing element 22, such as a switch or a button, may be provided within the casing 203, or to a lower portion of the casing 203, so that these elements may be controlled to be on or off when the user has pressed the control apparatus 200.

The user's inputting operation may also be measured using the piezo element itself. For example, when the control apparatus 200 is acted on by the user, the piezo element, enclosed within the control apparatus 200, is bowed to generate a signal. The input applied to the control apparatus 200 by the user may be detected with this signal. Of course, this same piezo element may be used to provide tactile feedback.

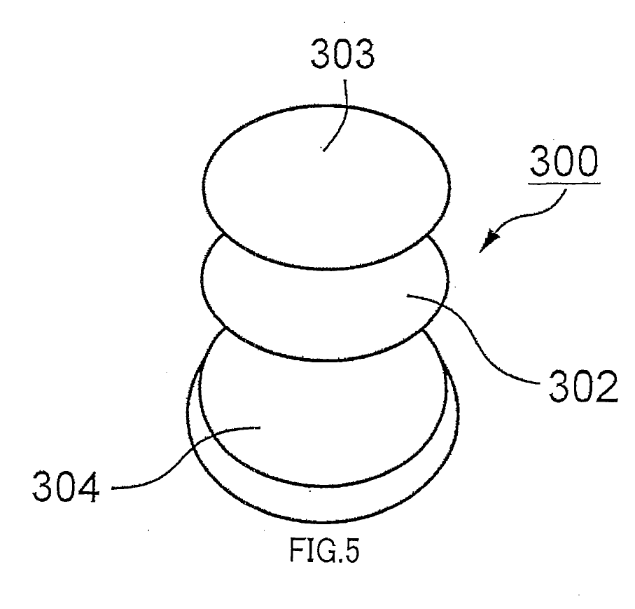

FIG. 5 shows an example of an operating unit 300 of a simplified structure having the built-in piezo actuator. In the example of FIG. 5, a piezo actuator 302 of a circular profile, such as is shown in FIGS. 3A to 3C, is mounted on a button having a corresponding circular profile (interfacing element 22). The piezo actuator 302 is covered up by a cover 303.

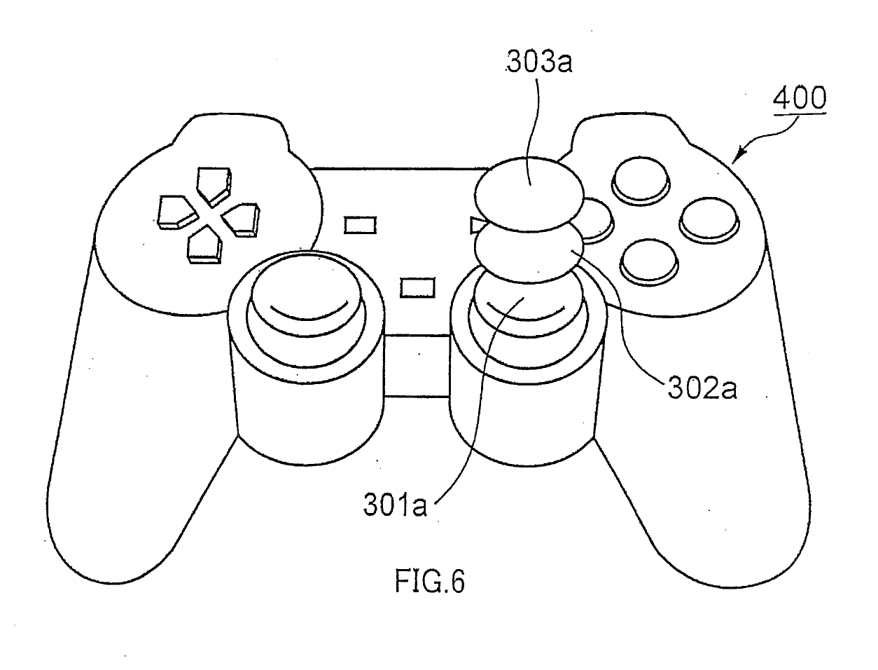

FIG. 6 shows an example of an apparatus in which the piezo actuator embodying the present invention is built in a control apparatus 400 for playing a game. In this example, as in the example shown in FIG. 5, a piezo actuator 302a is mounted to an operating part 301a of a joystick, provided to the control apparatus 400 for playing a game. A cover member 303a, formed e.g. of rubber, is further mounted to the piezo actuator 302a.

The present invention is not limited to the above embodiments explained with reference to the drawings and, as will be apparent to those skilled in the art, various changes, substitutions or equivalents may be attempted without departing from the scope of the invention as defined in the appended claims.

### INDUSTRIAL UTILIZABILITY

The tactile feedback according to the present invention is not limited to the above-described embodiments. For example, the present invention may be applied to other usages, such as mobile or portable devices in need of mechanical switches or controllers, such as remote controllers for PDA, mobile phone, wearable computers, or personal music playing apparatus. In particular, the tactile feedback according to the present invention is suited for use in a controller for playing a game which is capable of providing tactile feedback.

What is claimed is:

1. A tactile feedback apparatus comprising
an interfacing element acted on by a user;
a piezo actuator arranged on said interfacing element for presenting tactile feedback to a user acting on said interfacing element; and
a controller for driving controlling said piezo actuator;
said piezo actuator being of a circular-shaped multi-layered structure and having a shape changed to an upturned dome shape or to a downturned dome shape on application of voltages of opposite polarities to a plurality of layers in an upper portion of said multi-layered structure and to a plurality of layers in a lower portion of said multi-layered structure;
said controller controlling the change between the upturned dome shape and the downturned dome shape by a signal.

2. The tactile feedback apparatus as defined in claim 1 wherein at least one of the amplitude and the frequency in a change between said upturned dome shape and the downturned dome shape is determined depending on an inputting operation by a user mediated by said interfacing element.

3. The tactile feedback apparatus as defined in claim 1 further comprising
a force sensor for detecting the force applied at the time of the operation for inputting by a user; wherein
at least one of the amplitude and the frequency in a change between said upturned dome shape and the downturned dome shape is determined depending on the force as detected by said force sensor.

4. The tactile feedback apparatus as defined in claim 1 wherein
said interfacing element is a joystick operating device, a button device or a switch device.

5. A system comprising a main body part executing an application program and a user interface program and a control device mounted in separation from said main body part and adapted for controlling the state of said application program;
said control device including an interfacing element acted on by a user;
a piezo actuator arranged on said interfacing element for presenting tactile feedback to a user acting on said interfacing element; and
a controller for driving controlling said piezo actuator;
said piezo actuator being of a circular-shaped multi-layered structure and having a shape changed to an upturned dome shape or to a downturned dome shape on application of voltages of opposite polarities to a plurality of layers in an upper portion of said multi-layered structure and to a plurality of layers in a lower portion of said multi-layered structure;
said controller controlling the change between the upturned dome shape and the downturned dome shape by a signal;
such control by said controller being managed in keeping with the current state of said application program and the interface program.
